(19) United States
(12) Patent Application Publication
(10) Pub. No.: US 2024/0092182 A1
(43) Pub. Date: Mar. 21, 2024

(54) ELECTROMAGNETIC TRANSPORTATION WITH INTEGRATED SWITCHING, PROPULSION, GUIDANCE AND SUSPENSION

(71) Applicants: Dan Corns, Edmonton (CA); Tracy M. Clark, Bedford, MA (US); Magnovate Holdings Inc., Edmonton (CA)

(72) Inventors: Dan Corns, Edmonton (CA); Tracy M. Clark, Bedford, MA (US)

(21) Appl. No.: 18/464,212

(22) Filed: Sep. 9, 2023

Related U.S. Application Data
(60) Provisional application No. 63/375,888, filed on Sep. 16, 2022.

(51) Int. Cl. B60L 13/00; B60L 13/04; E01B 25/32; E01B 25/34

(52) U.S. Cl. CPC B60L 13/003; B60L 13/04; E01B 25/32; E01B 25/34

(57) ABSTRACT

The invention provides, in some aspects, a magnetic levitation transport system with a guideway having rails with propulsion windings extending therealong and defining first and second diverging paths. A vehicle disposed on the guideway has T-shaped propulsion pods extending toward to the guideway. Arms of the propulsion pods extend laterally from stems and include permanent magnets and control coils. These are disposed adjacent respective rails/windings. The propulsion pods and rails propel, switch, suspend, and guide a vehicle on the guideway.

This application claims the benefit of U.S. Patent Application 63/375,888, filed 16 Sep. 2022, entitled ELECTROMAGNETIC TRANSPORTATION WITH INTEGRATED SWITCHING, PROPULSION, GUIDANCE AND SUSPENSION, the teachings of which are incorporated herein by reference.

### BACKGROUND OF THE INVENTION

Cheaper, faster transportation has long been a tremendous catalyst for economic growth and wealth creation. From the first commercial steam train in 1830 to Henry Ford's mass-produced automobiles in 1908, the continual introduction of new transport modes allowed our cities to grow exponentially and, therefore, improved our standard of living by multiplying opportunities to access good jobs and affordable housing. For more than a century, we lived off the legacy of rapid innovation.

Magnetic levitation-based transportation is one such innovation whose time has yet to come. Maglev, as it is more commonly known, relies on moving magnetic fields to propel, guide and suspend passenger (or other load-carrying) vehicles. U.S. Pat. No. 6,983,701 describes one such maglev system. As noted by Bird, “A Review of Integrated Propulsion, Suspension and Guidance Passive Guideway Maglev Technologies,” 1-6, 10.1109/LDIA.2019.8770983, despite the attractiveness of maglev systems, its adoption has been hampered, in part, by the elaborate switching mechanisms needed to change vehicle direction. An object of the present invention is to overcome that obstacle.

More generally, an object of the invention is to provide improved transportation systems and methods.

A related object of the invention is to provide improved such systems and methods that utilize moving magnetic fields for propulsion, guidance and/or suspension.

A further object of the invention is to provide improved such systems and methods that provide for switching, that is, changing vehicle direction, without elaborate mechanisms.

### SUMMARY OF THE INVENTION

The foregoing are among the objects attained by the invention which provides, in some aspects, a magnetic levitation transport system with a guideway having at least a first rail with propulsion windings extending therealong and defining a first path. A vehicle disposed on the guideway has at least a first T-shaped propulsion pod extending from its base toward the guideway. At least a first arm of that T-shaped propulsion pod (i) extends laterally from a stem of that T-shape, and (ii) has disposed thereon a permanent magnet and a control coil. The permanent magnet and control coil of the first arm of the first propulsion pod are disposed (i) adjacent to the first rail and its propulsion windings, (ii) separated from the first rail and its propulsion windings by a gap sized to permit the permanent magnet and control coils of the first arm of the first propulsion pod to exert electromagnetic force on the first rail and its propulsion windings, and vice versa.

Related aspects of the invention provide a system, e.g., of the type described above, in which the first rail is laminated steel.

Further related aspects of the invention provide a system, e.g., of the type described above, in which the gap is an air gap.

Still further related aspects of the invention provide a system, e.g., of the type described above, wherein the vehicle is disposed above the guideway and is suspended through attraction of the permanent magnet of the first arm of the first propulsion pod with the first rail.

Yet still further related aspects of the invention provide a system, e.g., of the type described above, wherein the permanent magnet of the first arm of the first propulsion pod guides the vehicle along the guideway.

In another aspect, the invention provides a system, e.g., of the type described above, wherein the guideway comprises a second rail with propulsion windings extending therealong defining a second path that diverges from the first path. A second propulsion pod that extends from the base of the vehicle toward the guideway is T-shaped and has at least a first arm that (i) extends from a stem of that T-shaped propulsion pod, and (ii) has disposed thereon a permanent magnet and a control coil. The permanent magnet and control coil of the first arm of the second propulsion pod are disposed (i) adjacent to the second rail and its propulsion windings, (ii) separated from the second rail and its propulsion windings by a gap sized to permit the permanent magnet and control coils of the first arm of the second propulsion pod to exert electromagnetic force on the second rail and its propulsion windings, and vice versa, The vehicle is suspended through attraction of the permanent magnets of the first arms of the first and second propulsion pods with the first and second rails, respectively, and the permanent magnets of the first arms of the first and second propulsion pods guide the vehicle along the guideway.

In related aspects, the invention provides a system, e.g., of the type described above, wherein the second path diverges from the first path at a switching point of the guideway, with the first rail and second rail defining a left branch and right branch, respectively, of the guideway after the switching point.

In further related aspects, the invention provides a system, e.g., of the type described above, wherein the second rail parallels the first rail in a region of the guideway prior to the switching point.

In yet another aspect, the invention provides a system, e.g., of the type described above, wherein the guideway comprises a third rail with propulsion windings paralleling the first rail and also defining the first path. The first propulsion pod has a second arm that (i) extends from a stem of that T-shaped propulsion pod, and (ii) has disposed thereon a permanent magnet and a control coil. The permanent magnet and control coil of the second arm of the first propulsion pod are disposed (i) adjacent to the third rail and its propulsion windings, (ii) separated from the third rail and its propulsion windings by a gap sized to permit the permanent magnet and control coils of the second arm of the first propulsion pod to exert electromagnetic force on the third rail and its propulsion windings, and vice versa, The vehicle is suspended through attraction of the permanent magnets of the arms of the first and second propulsion pods with at least two of the first, second and third rails.

In yet another aspect, the invention provides a system, e.g., of the type described above, wherein the guideway comprises a fourth rail with propulsion windings extending therealong defining at least in part the second path. The second propulsion pod has at least a second arm that (i) extends from a stem of that T-shaped propulsion pod, and (ii) has disposed thereon a permanent magnet and a control coil. The permanent magnet and control coil of the second arm of the second propulsion pod are disposed (i) adjacent to the fourth rail and its propulsion windings, (ii) separated from the fourth rail and its propulsion windings by a gap sized to permit the permanent magnet and control coils of the second arm of the second propulsion pod to exert electromagnetic force on the fourth rail and its propulsion windings, and vice versa, The vehicle is suspended through attraction of the permanent magnets of the arms of the first and second propulsion pods with at least two of the first, second, third and fourth rails.

Yet still further aspects of the invention provide systems, e.g., of the type described above, wherein the guideway has a cross-section of any of an open polygon and a letter T, the first and second rails being disposed at or near termini of the guideway in lateral cross-section. Near the switching point, the guideway cross-section includes a medial structure that has arms that extend from a central support, the third and fourth rails being disposed at or near termini of that medial structure in lateral cross-section. In a region of the guideway remote from the switching point, (i) the permanent magnet and control coil of the first arm of the first propulsion pod is disposed adjacent to the first rail and its propulsion windings, and (ii) the permanent magnet and control coil of the first arm of the second propulsion pod is disposed adjacent to the second rail and its propulsion windings. In a region of the guideway near the switching point, (i) the permanent magnet and control coil of the first arm of the first propulsion pod is disposed adjacent to the first rail and its propulsion windings, (ii) the permanent magnet and control coil of the first arm of the second propulsion pod is disposed adjacent to the second rail and its propulsion windings, (iii) the permanent magnet and control coil of the second arm of the first propulsion pod is disposed adjacent to the third rail and its propulsion windings, and (iv) the permanent magnet and control coil of the second arm of the second propulsion pod is disposed adjacent to the fourth rail and its propulsion windings.

Further aspects of the invention provide systems as described above in which (i) path switching is effected by the vehicle itself (e.g., through activation and deactivation of the control coils on the propulsion pods) and does not require moving a switching beam or other mechanical element on the guideway, and (ii) can accommodate switching at a range of speeds.

Still further aspects of the invention provide such systems in which the propulsion pods wrap around the lateral ends of the guideway, thereby, protecting the system from the elements and contributing to its overall safety, e.g., against catastrophic failure.

These and other aspects of the invention are evident in the text that follows and in the drawings.

### BRIEF DESCRIPTION OF THE ILLUSTRATED EMBODIMENT

A more complete understanding of the invention may be attained by reference to the drawings, in which:

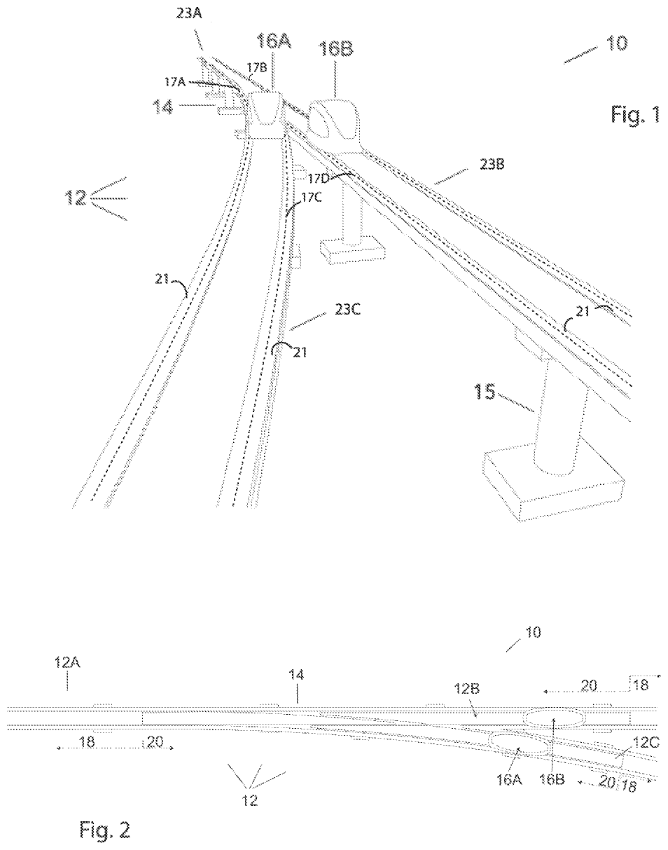

FIG. 1 depicts a maglev transport system according to one practice of the invention;

FIG. 2 is a top view of the system of FIG. 1;

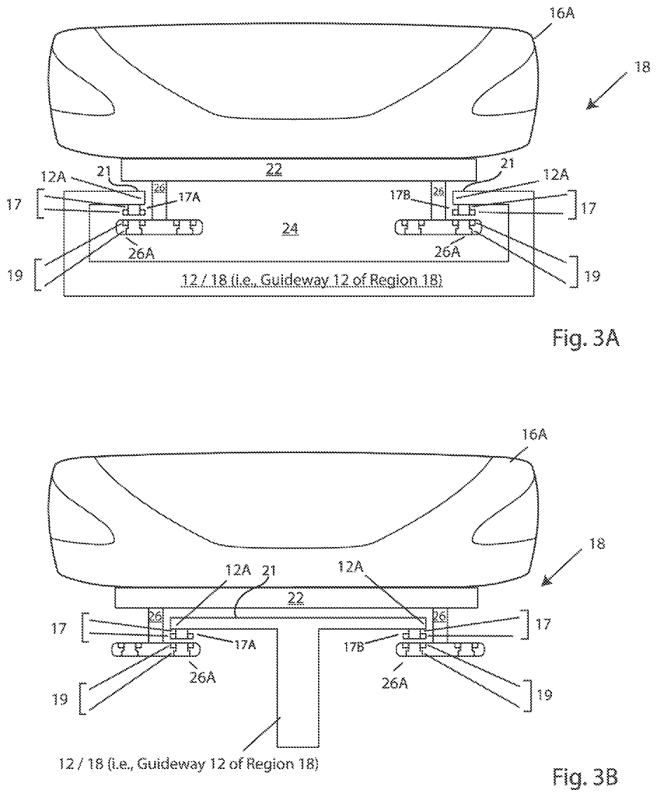

FIGS. 3A and 3B depict cross-sections of guideways according to various practices of the invention in regions remote from a switching point; and

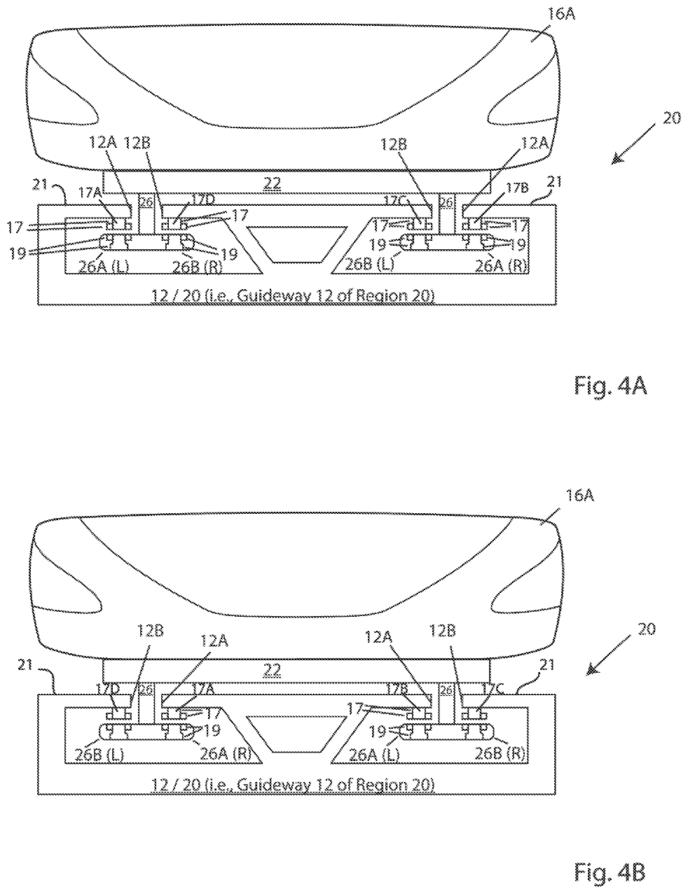

FIGS. 4A and 4B depict cross-sections of guideways according to various practices of the invention in regions near a switching point.

### DETAILED DESCRIPTION OF THE ILLUSTRATED EMBODIMENT

### Overview

FIG. 1 depicts a magnetic levitation (“maglev”) transport system 10 according to one practice of the invention. The illustrated system includes a guideway 12 having a trunk portion 23A that branches at switching point 14 into left and right branch portions 23B, 23C, respectively. The guideway 12 may be disposed on ground, over- or under-ground, as well as in other environments in which switching, propulsion, guidance, and/or suspension are magnetically mediated. In the illustrated embodiment, the guideway 12 is shown by way of non-limiting example in an over-ground configuration, as indicated by support pillars 15. Transported on guideway 12 are vehicles 16A, 16B, each for carrying persons, cargo or other things, and each of which may be covered (as shown in the drawing), open or otherwise. And, though, two vehicles 16A, 16B are shown in the drawing, other embodiments may support greater or lesser numbers of vehicles.

FIG. 2 is a top view of the system 10 shown in FIG. 1. As shown there, branch 23B is a straight-through and branch 23C is a right-hand turn. Other embodiments may differ in these regards; thus, for example, both branches 23B and 23C may comprise turns (or forks).

### Structures for Propulsion, Guidance, Suspension and Switching

Remote from Switching Points

FIGS. 3A and 3B depict a cross-section of guideway 12 in a region 18 remote from the switching point 14, that is, in a region where a vehicle, e.g., 16A, traveling thereon does not require switching. Also shown in the drawings is a propulsion base 22 of vehicle 16A traveling over the guideway 12 in that region 18. Although shown riding above the guideway 12 in the illustrated embodiments, other embodiments contemplate the vehicle riding under or beside the guideway, implementations of which are within the ken of those skilled in the art in view of the teachings hereof.

The cross-section of the guideway 12 of a region 18 (hereinafter, sometimes “guideway 12/18” for brevity) illustrated in FIG. 3A is configured as an open polygon, here, generally shaped like an upward-facing letter C, though other geometries may be utilized instead. For example, in the embodiment of FIG. 3B, the guideway 12/18 cross-section is shaped like a letter T having arms that extend distally from a central support stem, here, shown having a rectangular cross-section, though, as above, other support geometries may be utilized instead.

Laminated steel rails and propulsion windings 17 run along the guideway and are disposed at or near the lateral ends 12A of the guideway 12/18, here, shown at left and right and referred to as such. As used here, “lateral ends” refers to the termini 12A of the guideway 12/18 in lateral cross-section (that is, a cross-section of the type illustrated here that runs transverse or crossways to the direction of vehicle travel along the guideway). In the embodiment of FIG. 3A, those lateral ends lie on an outboard portion of guideway 12/18, while in the embodiment of FIG. 3B, they lie on an inboard portion of that guideway. The rails/windings 17 may be disposed on or be integral to the body of the guideway 12/18 at those termini 12A or, as shown in FIGS. 3A and 3B, they may be disposed on extensions of the body.

Propulsion pods 26 (or “skis”), here, each in the shape of an inverted letter T, extend from base 22 into the cavity 24 of the C-shaped guideway 12/18 in the embodiment of FIG. 3A; or, around the distal ends of the arms of T-shaped guideway 12/18 in the embodiment of FIG. 3B. Two such pods 26 are provided in each embodiment: one at left and one at right in the respective drawings, though, other embodiments may utilize a lesser or greater number of pods, positioned elsewise, as is within the ken of those skilled in the art in view of the teachings hereof. The left and right pods 26 and, correspondingly, the left and right rails/windings 17 in which they travel are spaced apart from one another laterally (i.e., transverse to the direction of vehicle motion along the guideway 12) sufficiently to provide support for vehicle 16A (e.g., to prevent it from tipping over) and to permit its motion to be switched from path to path as it is guided along guideway 12 near switching points, as more fully discussed below. Determination of such spacing, based on vehicle loads, guideway speeds and otherwise within the ken of those skilled in the art in view of the teachings hereof.

Permanent magnets and control coils 19 are disposed on the pods 16 in adjacent opposing relationship to the rails/windings 17 of the guideway 12/18. As used here, adjacent opposing means separated by and on opposite sides of an air (or other) gap, yet, sufficiently close that the magnets/coils 19 and rails/windings 17 can exert electromagnetic forces on one another for purposes of propulsion, guidance and suspension, as discussed below. In the illustrated embodiments, the magnets/coils 19 are disposed at or near lateral ends of each of arms that extend laterally from the stem of the T-shaped pods 26 adjacent respective rails/windings 17 of the guideway 12/18. That is, the magnets/coils 19 are disposed at or near the lateral ends 26A of the pods' respective arms adjacently opposed to respective rails/windings 17 at the termini 12A of the guideway, though, in other embodiments the geometries may differ. As above, as used here, “lateral ends” refers to termini 26A of the arms in lateral cross-section. And, as above, the magnets/coils 19 may be disposed on or be integral to the bodies of the respective pod's arms at those termini 26A as shown in FIGS. 3A and 3B, or they may be disposed on extensions of those arms.

In the illustrated embodiment, the rails/windings 17 (i) extend from a surface of the guideway 12/18 that has a normal oriented 180° from the normal to the running surface 21 of that guideway, and (ii) are disposed near but offset laterally from the lateral ends 12A. Likewise, the magnets/coils 19 are disposed near but offset medially, i.e., toward the respective stems of the T-shaped pods. It will be appreciated that reference to the “stem” and “arms” of the T-shaped pod are by analogy to the vertical stem and horizontal arms of the letter “T”.

In view of the configuration discussed above and shown in the drawing, it will be appreciated that each of the T-shaped pods “wraps around” the lateral ends of the guideway 12/18 on which the rails/windings 17 are disposed. That is, in the embodiment of FIG. 3A, the laterally directed arms 26A of pods 26 overlap (along an axis transverse to the direction of motion of vehicle 16A) the outboard portion of guideway 12/18 and, more specifically, the medially directed ends 12A of that portion of the guideway. Likewise, but conversely, in the embodiment of FIG. 3B, the medially directed arms 26A of pods 26 overlap (along the same aforesaid axis) an inboard portion of guideway 12/18 and, more specifically, the laterally directed ends 12A of that portion of the guideway. This is a safety feature that can protect the rails/windings 17 and magnets/coils 19 from exposure to the elements or otherwise, and that can prevent catastrophic failure of the system, e.g., in the event of power loss or otherwise.

Near Switching Points

FIGS. 4A and 4B depict a cross-section of guideway 12 in a region 20 near the switching point 14, that is, in a region where a vehicle, e.g., 16A, traveling thereon may require switching. As Also shown in the drawings is a propulsion base 22 of vehicle 16A traveling on guideway 12 in that region 20.

The guideways 12 of a region 20 (hereinafter, sometimes “guideway 12/20”) of the embodiments shown in FIGS. 4A and 4B are constructed identically to the corresponding embodiments shown in FIGS. 3A and 3B, respectively. Except, however, the embodiments shown in FIGS. 4A and 4B include additional structure, beyond that shown in FIGS. 3A and 3B, respectively, to support switching of vehicle 16A travelling in the region 20.

Specifically, like the guideway 12/18 of FIG. 3A, the guideway 12/20 of FIG. 4A has a portion configured as an open polygon and, more particularly, as an upward-facing letter C. The guideway 12/20 of FIG. 4A has additional structure, however: a medial portion that is constructed like the guideway 12/18 of FIG. 3B, to wit, a portion that is shaped like a letter T (albeit, with a truncated triangular stem rather than a rectangular one) with arms that extend from a central support. Paralleling the embodiment of FIG. 3B, that additional, medial portion of the embodiment of FIG. 4A includes rails/windings 17 are disposed at or near (and, in the illustrated embodiment, offset from) the lateral ends 12B of the guideway 12/20, and that are disposed in adjacent opposing relationship to magnets/coils 19 at lateral ends 26B of the respective arms of the pods 26, as shown. As discussed above, the geometries of other embodiments of the guideway 12/20 may deviate from those shown in FIG. 4A.

Similarly, like the guideway 12/18 of FIG. 3B, the guideway 12/20 of FIG. 4B has a portion shaped like a letter T (albeit, with a truncated triangular stem rather than a rectangular one) with arms that extend from a central support. The guideway 12/20 of FIG. 4B has additional structure, however: a medial portion that is constructed like the guideway 12/18 of FIG. 3A that is an open polygon and, more particularly, as an upward-facing letter C. Paralleling the embodiment of FIG. 3A, that additional, medial portion of the embodiment of FIG. 4B includes rails/windings 17 that are disposed at or near (and, in the illustrated embodiment, offset from) the lateral ends 12B of the guideway 12/20, and that are disposed in adjacent opposing relationship to magnets/coils 19 at lateral ends 26B of the respective arms of the pods 26, as shown.

As discussed above in connection with FIGS. 3A, 3B, the illustrated configuration, including offsetting of the rails/windings 17 from the lateral ends of the guideway 12A, 12B and the magnets/coils 19 from the ends of the arms of the pods 26, provides propulsion pods that wrap around the lateral ends of the guideway and add to protection of and safety of the system. In this regard, in embodiment of FIG. 4A, not only do the laterally directed arms 26A of pods 26 overlap (along an axis transverse to the direction of motion of vehicle 16A) an outboard portion of guideway 12/20 and, more specifically, the medially directed ends 12A of that portion of the guideway, but also the medially directed arms 26B of those pods overlap (along that same axis) the inboard portion of that guideway 12/20 and, more specifically, the laterally directed ends 12B of that portion of the guideway. Likewise but conversely, in the embodiment of FIG. 4B, not only do the medially directed arms 26A of pods 26 overlap (along the same aforesaid axis) an inboard portion of guideway 12/20 and, more specifically, the laterally directed ends 12A of that portion of the guideway, but also the laterally directed arms 26B of pods 26 overlap (along that same axis) an outboard portion of guideway 12/20 and, more specifically, the medially directed ends 12B of that portion of the guideway.

As discussed above, the geometries of other embodiments of the guideway 12/20 may deviate from those shown in FIG. 4B.

As evident in the drawings and discussion above, the guideway 12 of the illustrated embodiment need only include two rails 17a, 17b running parallel to one another to define a trunk (whether a straight-away, a curve or otherwise) prior to a switching point 14. After switching point 14, those rails 17A, 17B diverge from one another, each defining (in whole or in part) a respective one of the left branch 23B and the right branch 23C of the guideway 12. (As used here, ‘prior” and “after” are used in reference to the portions of the guideway 12 on which the vehicle 16A, 16B travels before and after passing the switching point.) In the illustrated embodiment, two more medially disposed rails 17C, 17D are provided paralleling respective ones of the diverging rails 17A, 17B, as shown, to ensure adequate propulsion, guidance, suspension and switching the vehicle if/as it takes are respective one of those branches 23B, 23C. Selection of the degree of curvature of branching rails 17A-17D, as well as the length of the medial rails 17C-17D and the medial portion of the guideway structure 12/20 on which they are disclosed is dependent on expected vehicle loads, guideway speeds and is otherwise within the ken of those skilled in the art in view of the teachings hereof.

Propulsion, Guidance and Suspension Remote from Switching Points

With reference to FIGS. 3A and 3B, vehicle 16A of the illustrated embodiment is propelled, guided and suspended along guideway 12/18 as a result of the interaction between the (i) permanent magnets and control coils 17 disposed on lateral ends 26A of the arms of pods 26, one the one hand, and (ii) laminated steel rails with propulsion windings 19 disposed on the lateral ends 12A of guideway 12/18.

Such propulsion, guidance and suspension is within the ken of those skilled in the art and can be accomplished, by way of non-limiting example, in like manner (as adapted in accord with the teachings hereof) to that of the guideway and vehicle disclosed in U.S. Pat. No. 6,983,701 (the '701 patent), the teachings of which are incorporated herein by reference (see, for example, the discussion at FIGS. 1-6 and 8-10, and the accompanying text, e.g., at column 1, line 16-column 9, line 61 of the '701 patent, all of which figures and text are incorporated by reference herein), taking into account the difference between the vehicle/guideway geometry shown in FIGS. 3A and 3B of the instant application and the vehicle/guideway geometry shown in the '701 patent.

Thus, by way of example, like that disclosed the '701 patent, the vehicle 16A of the illustrated embodiment is suspended through attraction of an array of permanent magnets 19 on lateral ends 26A of each of the pods 26 with adjacent opposing laminated steel rails 17 on lateral ends 12A of each of the respective sides of the guideway 12/18, again, all as adapted in accord with the teachings hereof. Moreover, by way of further example, those same permanent magnets 19 that provide suspension (or “lift”) in the illustrated embodiment also serve to guide the vehicle 16A along the guideway 12/18, as disclosed the '701 patent, again, as adapted in accord with the teachings hereof.

Dimensioning of the guideway 12/18 and vehicle 16A of the illustrated embodiment relevant to the provision of such propulsion, guidance and suspension is within the ken of those skilled in the art and can be determined, by way of example, in accord with the '701 patent at col. 4, line 35-col. 5, line 7, the teachings of which are incorporated herein by reference, all as adapted in accord with the teachings hereof.

The choice of pole pitch and magnet size, magnet type and configuration, and end magnets, of the laminated steel rails and propulsion windings on lateral ends 12A of guideway 12/18, on the one hand, and the permanent magnets and control coils on the lateral ends 26A of the pods 26, on the other hand, is within the ken of those skilled in the art and can be made, for example, in the manner shown in FIGS. 2a, 2b and 3-4 of the '701 patent and discussed in the accompanying text at col. 5, line 7-col. 7, line 12 of the '701 patent, the teachings of which are incorporated herein by reference, all as adapted in accord with the teachings hereof.

As with the guideway of the '701 patent, it will be appreciated that the guideway 12 of the illustrated embodiment, with its laminated steel rails and propulsion windings 17, functions as a stator of a linear synchronous motor (LSM) and the vehicle, with its pod-mounted permanent magnets and control coils 19, functions as the rotor. The dimensions of these is within the ken of those skilled in the art and they can be sized, for example, as discussed in U.S. Pat. No. 6,917,136 (the '136 patent), the teachings of which are incorporated herein by reference, including, specifically, by way of non-limiting example, the teachings of FIGS. 1B, 2B, 4A, 4B, 5-8 of the '136 patent and the corresponding text thereof, all as adapted in accord with the teachings hereof.

Control of the propulsion windings on lateral ends 12A of guideway 12, on the one hand, and the control coils on the lateral ends 26A of the pods 26, on the other hand, of the illustrated embodiment for propulsion and suspension is within the ken of those skilled in the art and can be effected, for example, in the manner shown in FIG. 5 of the '701 patent and described in the accompanying text at col. 7, lines 12-52 of the '701 patent, the teachings of which are incorporated herein by reference, all as adapted in accord with the teachings hereof.

Moreover, the construction, operation and control of the LSM defined by the guideway 12 of the illustrated embodiment is within the ken of those skilled in the art and can be accomplished, for example, in the manner of that shown in FIG. 6 of the '701 patent and described in the '701 patent at col. 7, lines 53-67, the teachings of which are incorporated herein by reference, along with those of the '136 patent, by way of non-limiting example, at FIGS. 1B, 2B, 4A, 4B, 5-8 of the '136 patent and the corresponding text thereof, all of which too are incorporated herein by reference, and all as adapted in accord with the teachings hereof.

Damping of lateral forces by the guideway 12 and vehicle 16A of the illustrated embodiment is within the ken of those skilled in the art and can be achieved, for example, in the manner shown in FIGS. 8-10 of the '701 patent and described in the accompanying text at col. 8, line 32-col. 9, line 3 of that patent, all of which are incorporated herein by reference, as adapted in accord with the teachings hereof.

### Propulsion, Guidance, Suspension and Switching Near Switching Points

With reference to FIGS. 4A and 4B, vehicle 16A of the illustrated embodiment is propelled, guided, suspended and switched on guideway 12/20 as a result of the interaction between the (i) permanent magnets and control coils 17 disposed on lateral ends 26A and 26B of the arms of pods 26, on the one hand, and (ii) laminated steel rails with propulsion windings 19 disposed on the lateral ends 12A and 12B of guideway 12/20, on the other hand. An advantage of this configuration is that path switching can be effected by the vehicle itself (e.g., through activation and deactivation of the control coils on the propulsion pods). It does not require moving a switching beam or other mechanical element on the guideway. It also permits switching to be accommodated at a range of vehicle speeds, e.g., depending on the length of the additional, medial portion of the guideway structure shown in FIGS. 4A, 4B discussed above.

More particularly, such propulsion, guidance and suspension is achieved through interaction of the arrays of permanent magnets and control coils 19 on lateral ends of the pods 26 with the laminated steel rails and propulsion coils 17 on the adjacent opposing lateral ends of the respective sides of the guideway 12/20, all in like manner to that discussed above, under the heading “Propulsion, Guidance and Suspension Remote from Switching Points,” with respect to guideway 12/18. However, in the region of the guideway 12/20 near switching point 14, not all magnet arrays on the pods 26 are active at all times: rather, those arrays are selectively activated and deactivated in order to garner propulsion, guidance and suspension from those rails/coils 17 of the guideway 12/20 that will take the vehicle, at the behest of a human operator or otherwise, along the path defined by the rails/coils 17 of the left branch or, alternatively, the path defined by the right branch of the guideway 12/20 at that switching point 14. As will be appreciated, a magnet array of a pod 26 can be activated or deactivated by altering the magnitude and direction of current flow in the control coils 19 of the permanent magnets 19 that make up the array. Specifically, for example, in order to take a left branch 23B of the type shown in FIGS. 1 and 2, the magnet arrays 19 on the left outer and right inner lateral ends of the pods 26 are activated (i.e., the lateral ends parenthetically labelled with an “L” in FIGS. 4A and 4B, thus, lateral ends 26A (L) and 26B (L)), while the magnet arrays 19 on the left inner and right outer lateral ends of the pods are disengaged (i.e., the lateral ends parenthetically labelled with an “R” in FIGS. 4A and 4B, thus, lateral ends 26A (R) and 26B (R)).

On the other hand, in order to take a right branch 23C of the type shown in FIGS. 1 and 2, the magnet arrays 19 on the right outer and left inner lateral ends of the pods 26 are activated (i.e., the lateral ends parenthetically labelled with an “R” in FIGS. 4A and 4B, thus, lateral ends 26A (R) and 26B (R)), while the magnet arrays 19 on the right inner and left outer lateral ends of the pods are disengaged (i.e., the lateral ends parenthetically labelled with an “L” in FIGS. 4A and 4B, thus, lateral ends 26A (L) and 26B (L)).

### CONCLUSION

Described above are improved transportation systems and methods that utilize moving magnetic fields for propulsion, guidance and/or suspension and that provide for switching without elaborate mechanisms. It will be appreciated that the embodiments shown in the drawings and described above are merely examples of the invention and that other embodiments varying from those shown here are contemplated by the invention.

In view of the foregoing, what we claim is:

1. A magnetic levitation transport system comprising:
A. a guideway having at least a first rail extending therealong and defining at least in part a first path, the first rail having propulsion windings extending therealong,
B. a vehicle disposed on the guideway,
C. at least a first propulsion pod extending from a base of the vehicle toward to the guideway, the first propulsion pod being T-shaped and having at least a first arm that (i) extends laterally from a stem of that T-shaped propulsion pod, and (ii) has disposed thereon a permanent magnet and a control coil,
D. where the permanent magnet and control coil of the first arm of the first propulsion pod are disposed (i) adjacent to the first rail and its propulsion windings, (ii) separated from the first rail and its propulsion windings by a gap sized to permit the permanent magnet and control coils of the first arm of the first propulsion pod to exert electromagnetic force on the first rail and its propulsion windings, and vice versa.

2. The system of claim 1, wherein the first propulsion pod wraps around a lateral end of any of an inboard portion and an outboard portion of the guideway on which the first rail is disposed.

3. The system of claim 1, wherein the gap is an air gap.

4. The system of claim 1, wherein the vehicle is disposed above the guideway and is suspended through attraction of the permanent magnet of the first arm of the first propulsion pod with the first rail.

5. The system of claim 1, wherein the permanent magnet of the first arm of the first propulsion pod guides the vehicle along the guideway.

6. The system of claim 1, wherein
A. the guideway comprises a second rail extending therealong defining at least in part a second path that diverges from the first path, the second rail having propulsion windings extending therealong,
B. a second propulsion pod extending from the base of the vehicle toward to the guideway, the second propulsion pod being T-shaped and having at least a first arm that (i) extends from a stem of that T-shaped propulsion pod, and (ii) has disposed thereon a permanent magnet and a control coil,
C. where the permanent magnet and control coil of the first arm of the second propulsion pod are disposed (i) adjacent to the second rail and its propulsion windings, (ii) separated from the second rail and its propulsion windings by a gap sized to permit the permanent magnet and control coils of the first arm of the second propulsion pod to exert electromagnetic force on the second rail and its propulsion windings, and vice versa,
D. the vehicle is suspended through attraction of the permanent magnets of the first arms of the first and second propulsion pods with the first and second rails, respectively,
E. the permanent magnets of the first arms of the first and second propulsion pods guide the vehicle along the guideway, and
F. the second propulsion pod wraps around a lateral end of any of an inboard portion and an outboard portion of the guideway on which the second rail is disposed.

7. The system of claim 6, wherein
A. the second path diverges from the first path at a switching point of the guideway, the first rail and second rail defining a left branch and right branch, respectively, of the guideway after the switching point, and
B. switching of the vehicle as between the first path and the second path is effected by activation and deactivation of the control coils on the propulsion pods of the vehicle.

8. The system of claim 7, wherein the second rail parallels the first rail in a region of the guideway prior to the switching point.

9. The system of claim 7, wherein
A. the guideway comprises a third rail extending therealong paralleling the first rail and also defining at least in part the first path, the third rail having propulsion windings extending therealong,
B. the first propulsion pod having at least a second arm that (i) extends from a stem of that T-shaped propulsion pod, and (ii) has disposed thereon a permanent magnet and a control coil,
C. where the permanent magnet and control coil of the second arm of the first propulsion pod are disposed (i) adjacent to the third rail and its propulsion windings, (ii) separated from the third rail and its propulsion windings by a gap sized to permit the permanent magnet and control coils of the second arm of the first propulsion pod to exert electromagnetic force on the third rail and its propulsion windings, and vice versa,
D. the vehicle is suspended through attraction of the permanent magnets of the arms of the first and second propulsion pods with at least two of the first, second and third rails, and
E. the permanent magnet of the second arm of the first propulsion pod guides the vehicle along the first path of the guideway.

10. The system of claim 9, wherein
A. the guideway comprises a fourth rail extending therealong paralleling the second rail and also defining at least in part the second path, the fourth rail having propulsion windings extending therealong,
B. the second propulsion pod having at least a second arm that (i) extends from a stem of that T-shaped propulsion pod, and (ii) has disposed thereon a permanent magnet and a control coil,
C. where the permanent magnet and control coil of the second arm of the second propulsion pod are disposed (i) adjacent to the fourth rail and its propulsion windings, (ii) separated from the fourth rail and its propulsion windings by a gap sized to permit the permanent magnet and control coils of the second arm of the second propulsion pod to exert electromagnetic force on the fourth rail and its propulsion windings, and vice versa,
D. the vehicle is suspended through attraction of the permanent magnets of the arms of the first and second propulsion pods with at least two of the first, second, third and fourth rails, and
E. the permanent magnet of the second arm of the second propulsion pod guide the vehicle along the second path of the guideway.

11. A magnetic levitation transport system comprising:
A. a guideway having a first rail, a second rail, a third rail, and a fourth rail, each extending along the guideway and each propulsion windings extending therealong, the first and second rails paralleling one another in a region before a switching point and diverging from one another in a region of the guideway after a switching point, the third rail paralleling the first rail in the region after the switching point, the fourth rail paralleling the second rail in the region after the switching point,
B. the guideway having a cross-section of any of an open polygon and a letter T, the first and second rails being disposed at or near termini of the guideway in lateral cross-section,
C. the guideway cross-section including near the switching point a medial structure that has arms that extend from a central support, the third and fourth rails being disposed at or near termini of that medial structure in lateral cross-section,
D. a vehicle that that travels over, under or beside the guideway,
E. first and second propulsion pods extending from the vehicle toward to the guideway, each of the first and second propulsion pods being T-shaped and having first and second arms that (i) extend laterally from a stem of that respective T-shaped propulsion pod, and (ii) each have disposed thereon a permanent magnet and a control coil,
F. in a region of the guideway remote from the switching point, (i) the permanent magnet and control coil of the first arm of the first propulsion pod is disposed adjacent to the first rail and its propulsion windings, and (ii) the permanent magnet and control coil of the first arm of the second propulsion pod is disposed adjacent to the second rail and its propulsion windings,
G. in a region of the guideway near from the switching point, (i) the permanent magnet and control coil of the first arm of the first propulsion pod is disposed adjacent to the first rail and its propulsion windings, (ii) the permanent magnet and control coil of the first arm of the second propulsion pod is disposed adjacent to the second rail and its propulsion windings, (iii) the permanent magnet and control coil of the second arm of the first propulsion pod is disposed adjacent to the third rail and its propulsion windings, and (iv) the permanent magnet and control coil of the second arm of the second propulsion pod is disposed adjacent to the fourth rail and its propulsion windings, and
H. the permanent magnet and control coil of each of the arms is separated from the rail and its propulsion windings adjacent to which it is disposed by a gap sized to permit the permanent magnet and control coils of that arm to exert electromagnetic force on that rail and its propulsion windings, and vice versa.

12. The system of claim 11, wherein the propulsion pods wrap around respective lateral ends of any of an inboard portion and an outboard portion of the guideway on which the rails disposed adjacent to magnets and control coils of those pods are disposed.

13. The system of claim 11, wherein switching of the vehicle as between the first path and the second path is effected by activation and deactivation of the control coils on the propulsion pods of the vehicle.

14. The system of claim 11, wherein the vehicle is disposed above the guideway and is suspended through attraction of the permanent magnets and the rails adjacent to which they are disposed.

15. The system of claim 11, wherein the permanent magnets guide the vehicle along the guideway.
